(19) United States
(12) Patent Application Publication
(10) Pub. No.: US 2017/0232715 A1
(43) Pub. Date: Aug. 17, 2017

(54) FLEXIBLE CONTAINER AND A PROCESS FOR MAKING A FLEXIBLE CONTAINER

(71) Applicant: Dow Global Technologies LLC, Midland, MI (US)

(72) Inventors: Bernard Fehr, Bad Ragaz (CH); Joerg-Peter Weltert, Zurich (CH)

(21) Appl. No.: 15/504,661

(22) PCT Filed: Aug. 20, 2015
(86) PCT No.: PCT/US2015/045987

§ 371 Date: Feb. 17, 2017

Related U.S. Application Data
(60) Provisional application No. 62/040,060, filed on Aug. 21, 2014.

(51) Int. Cl. B32B 27/06; B32B 3/30; B32B 5/18; B32B 15/04; B32B 27/08; B65D 75/00; B32B 27/34; B32B 27/32; B65B 9/20; B65B 51/22; B65D 65/40; B65D 75/40; B32B 3/28; B32B 27/30

(52) U.S. Cl. CPC B32B 27/065; B32B 3/28; B32B 3/30; B32B 5/18; B32B 15/046; B32B 27/08; B32B 27/304; B32B 27/34; B32B 27/306; B32B 27/32; B65B 9/20; B65B 51/225; B65D 65/40; B65D 75/40; B65D 75/008; B32B 2266/025; B32B 2266/08; B32B 2307/31; B32B 2307/7242; B32B 2439/40

(57) ABSTRACT

A flexible container comprising a multilayer structure which comprises a barrier layer; a sealing layer, and a third layer between the barrier and sealing layers which comprises a foamed polyolefin, wherein the container includes crease lines formed by localized thermal compaction of the foamed polyolefin is provided. Also provided is a method of making a flexible container.

### FIELD OF INVENTION

The disclosure relates to a flexible container and a process for making a flexible container.

### BACKGROUND OF THE INVENTION

Forming of a self-standing (also known as monolithic) containers out of flexible structures is difficult, because the flexible laminates typically used have recovery properties which prevent the formation of well-defined folding lines and/or supporting edges. Existing methods such as cutting and high pressure squeezing used in conventional forming processes may damage the barrier properties of the final container and may prevent complete sealing in the formation of the container.

### SUMMARY OF THE INVENTION

The disclosure is for a flexible container and a process for making a flexible container.

In a first embodiment, the disclosure provides a flexible container comprising a multilayer structure which comprises a barrier layer, a sealing layer and a foamed polyolefin between the barrier and sealing layers, and wherein the container includes crease lines formed by localized thermal compaction of the foamed polyolefin.

In another embodiment, the disclosure provides a process of preparing a flexible container comprising (a) selecting a multilayer structure having a barrier layer, a sealing layer and a foamed polyolefin layer disposed the barrier and sealing layers; and (b) thermally creasing the film along predetermined lines to form crease lines in at least the foamed polyolefin layer.

### BRIEF DESCRIPTION OF THE DRAWINGS

FIG. 1 is a first embodiment of a multilayer structure which may be used in forming the flexible container of the disclosure;

FIG. 2 is a second embodiment of a multilayer structure which may be used in forming the flexible container of the disclosure;

FIG. 3 is a third embodiment of a multilayer structure which may be used in forming the flexible container of the disclosure;

FIG. 4 is a fourth embodiment of a multilayer structure which may be used in forming the flexible container of the disclosure;

FIG. 5 is a schematic illustrating the multilayer structure shown in FIG. 1 following the formation of a crease line; and

FIG. 6 is a schematic of one form of equipment, shown in perspective, which may be used to thermally crease the multilayer structure.

### DETAILED DESCRIPTION OF THE INVENTION

The disclosure provides a flexible container and a process for making a flexible container.

As used herein, the term “localized thermal compaction” means compaction caused by application of heat or induction of heat by any method capable of exciting the molecules of the foamed polyolefin layer or an additive to the foamed polyolefin layer, such as by application of ultrasonic waves, such that the temperature of the foamed polyolefin reaches a temperature between −5 to +25° C. of the DSC melting point of the foamed polyolefin along predetermined lines and wherein the heating is accompanied by application of mechanical pressure along the predetermined lines.

As used herein, the term “thermally creasing” means the process of exciting the molecules of the foamed polyolefin layer or an additive to the foamed polyolefin layer, for example, by application of ultrasonic waves, such that the temperature of the foamed polyolefin reaches a temperature between −5 to +25° C. of the DSC melting point of the foamed polyolefin along predetermined lines and wherein the heating is accompanied by application of mechanical pressure along the predetermined lines. One of ordinary skill in the art would understand that methods other than application of ultrasonic waves fall within “thermally creasing.” For example, other types of radiation, such as microwave or infrared, may be applied along the predetermined lines. Alternatively, conventional conductive heating along the predetermined lines may be used. In each instance, however, the heating of the foamed polyolefin is accompanied by application of mechanical pressure along the predetermined lines to cause compaction of the foamed polyolefin and formation of crease(s) in the multilayer structure.

As used herein, the term “metallized layer” means a polymer layer onto which a thin metal layer has been deposited. The thin metal layer may be applied using any technique, for example, using a physical vapor deposition process wherein the metal used for the coating is vaporized and deposited onto a sheet of polymer film, all under vacuum or atmospheric pressure, or using chemical deposition methods. Any acceptable metal may be used, including for example aluminum, nickel and chromium. Typical polymer substrates for the in the metallized layer include polypropylene (PP), oriented polypropylene (OPP), polyethylene (PE), and polyethylene terephthalate (PET).

As used herein, the predetermined lines include a line along which a crease is desired and having a maximum of 5 mm line width. All individual values and subranges from up to 5 mm are disclosed and included herein. For example, the line width may be up to 5 mm, or in the alternative, up to 4 mm, or in the alternative, up to 3 mm.

As used herein, foamed polyolefin means a foamed polyolefin layer made as described in EP 1646677, the disclosure of which is incorporated by reference in its entirety herein.

As used herein, a closed cell foam is a foam which contains 80% or more closed cells or less than 20% open cells measured according to ASTM D2856-A.

“Sealing layer” means the outer layer(s) involved in the sealing of the film to itself, another layer of the same or another film, another article which is not a film or a combination thereof.

As used herein, high density polyethylene (HDPE) means polyethylenes having a density from 0.94 to 0.97 g/cc.

As used herein, low density polyethylene (LDPE) means polyethylenes having a density from 0.91 to 0.94 g/cc. Linear low density polyethylene (LLDPE) is characterized by little, if any, long chain branching, in contrast to conventional LDPE. The processes for producing LLDPE are well known in the art and commercial grades of this polyolefin resin are available. For example LLDPE may be produced in gas-phase fluidized bed, liquid phase solution, slurry loop or hybrid processes using a catalyst system. For example, LLDPE may be produced using Ziegler-Natta, metallocene, multiple- or single-site catalysts, or any combination thereof.

The melting point of the foamed polyolefin is measured by differential scanning calorimetry using ISO 11357, parts 1 to 7. The melting point is defined as the highest peak in the second run after a first run and recrystallization cycle.

The linear low density polyethylenes and low density polyethylenes typically have polymerized therein at least one α-olefin. The term “interpolymer” used herein indicates the polymer can be a copolymer, a terpolymer or any polymer having more than one polymerized monomer. Monomers usefully copolymerized with ethylene to make the interpolymer include the C3-C20 α-olefins, and especially propylene, 1-butene, 1-pentene, 1-hexene, 4-methyl-1-pentene, 1-heptene and 1-octene. Especially preferred comonomers include propylene, 1-butene, 1-hexene and 1-octene.

The present process utilizes localized thermal compaction to form crease lines in the multilayer structure. One method for creating the crease lines utilizes ultrasonic waves to heat the polyolefin foam. The use of ultrasonic waves includes application of an ultrasonic apparatus to produce an ultrasonic seal between two polymeric films. An ultrasonic apparatus includes the following components.

(1) An anvil wherein the multilayer structure is subjected to mechanical pressure. The anvil allows high frequency vibration to be directed to the multilayer structure along predetermined lines. The anvil includes an energy director which contacts one surface of the multilayer structure.

(2) An ultrasonic stack including (a) a converter (converts electrical signal into a mechanical vibration), (b) a booster (modifies the amplitude of the vibration) and (c) a horn (applies the mechanical vibration to the parts to be heated). The horn is also referred to as a sonotrode. All three elements of the ultrasonic stack are tuned to resonate at the same ultrasonic frequency (typically from 15 kHz, 20 kHz, 30 kHz, 35 kHz, to 40 kHz or 70 kHz).

Subjecting the multilayer structure to the ultrasonic energy causes local softening of the polyolefin foam due to absorption of vibration energy. The vibrations are introduced along the predetermined lines.

In ultrasonic softening the bars (horn and anvil pair) are typically at ambient temperature, and ultrasonic generation and flow are dependent variables that are governed by contact geometry, oscillation amplitude and frequency, static load and material selection. The ultrasonic energy necessary to achieve softening at the interface is generated internally within the polymer. For a given frequency and contact geometry, the process variables influencing ultrasonic softening formation are the amplitude of the oscillations and the superimposed seal force applied through the horn. Elevated temperatures needed to facilitate ultrasonic softening are generated internally, by partial dissipation of deformation energy into ultrasonic, as governed by viscoelastic characteristics of the polyolefin. The dissipated energy gives rise to an increase in temperature, the magnitude of which depends on the ultrasonic capacity of the system.

For oscillatory deformation in the linear viscoelastic regime, the rate of ultrasonic generation per unit volume (per sinusoidal cycle of tensile deformation) is shown in Equation (1):

\dot{Q}=πfε²E″ (1)

where f is the frequency of oscillations,
ε is the deformation amplitude, and
E″ is the loss modulus.

Equation (1) shows that the rate of ultrasonic generation is linearly proportional to loss modulus for a given amplitude and frequency of deformation, whereas the dependence on oscillation amplitude is to the second power. Direct application of Equation (1) to ultrasonic deformation is problematic because (i) the deformation is not homogenous, (ii) a substantial amount of the material in the softening area is non-isothermal, and (iii) the amplitude E in the above equation is not that of the horn, but that of the deformation applied to the material. In the present disclosure, the deformation amplitude is generally from 8 to 20 microns.

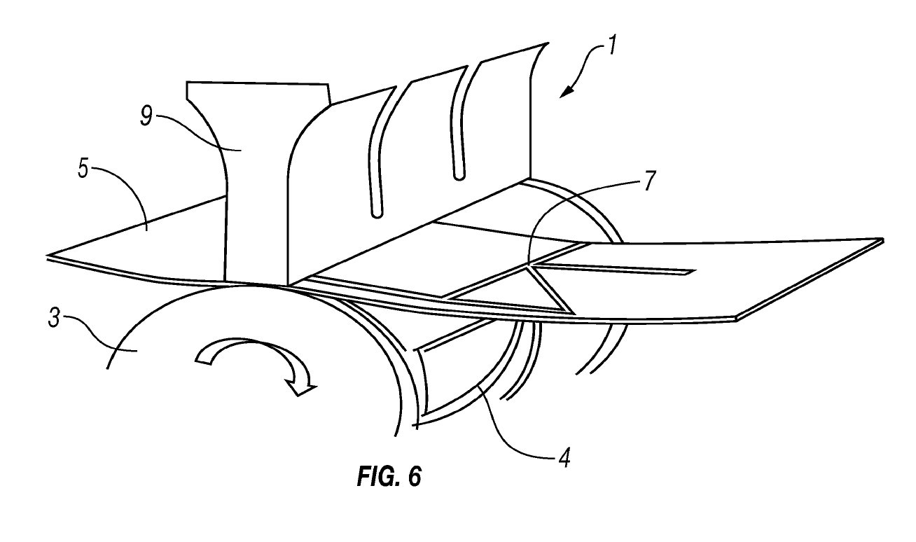

FIG. 6 illustrates a form of equipment 1 useful in thermally creasing the multilayer structure as described herein. As seen in FIG. 6, an anvil drum 3 has raised portions 4 in a pattern to be transferred onto the multilayer structure 5 as crease lines 7. The sonotrode 9 pushes down upon the multilayer structure 5 with the deformation amplitude from 8 to 20 microns.

Any foamed polyolefin amenable to softening using ultrasonic waves may be used. One method of determining which polyolefins are amendable to ultrasonic softening is described below.

In view of Equation (I) above, Applicant has developed parameters to determine whether a polymer is suited for ultrasonic heating. First, based on scaling between ultrasonic generation rate and loss modulus, a polymer exhibiting a high loss modulus at the onset of horn oscillations is desired for rapid ultrasonicing and/or softening.

Second, the square dependence of rate of ultrasonic generation on deformation amplitude suggests that polymers of lower rigidity are desired as this will allow a larger deformation amplitude to be realized in the polymer for a given pressure on the horn. Even though increasing the pressure on the horn may enhance the deformation amplitude in the polymer at the start of oscillations, a minimal pressure on the horn to produce compaction of the foam (by locally collapsing the cells) is desired while avoiding melting and destruction of the entire foam layer. Because the modulus of a semi-crystalline polymer may drop more than two orders of magnitude upon melting, using a large pressure on the horn could lead to excessive melting and destruction of the entire foam layer. To ensure maximum ultrasonic generation with a minimal pressure on the horn, it is desired to select polymer with low modulus, so as to produce maximal amplitude of oscillations early on in the ultrasonicing cycle. Polymers with lower modulus at ambient conditions also have a smaller difference between solid and melt-state modulus—an additional factor that prevents excessive flow of material in the melt. Based on foregoing, at the onset of deformation, polymers featuring a high loss modulus combined with a low storage modulus are desired.

Third, the ultrasonic generated due to viscoelastic dissipation raises the temperature—thereby softening the semi-crystalline at the crease lines. Polymers with a low temperature for softening are desired for rapid ultrasonic heating or softening characteristics. For such polymers the duration of oscillations necessary to soften the polymer, can be significantly short, hence a shorter cycle time.

Exemplary polyolefin foams include foams which are made from linear low density polyethylene, low density polyethylene, polypropylenes (including copolymers of ethylene and propylene) and mixtures or blends thereof. Such blends are described in U.S. Published Application 20080138593, the disclosure of which is incorporated herein in its entirety by reference. Commercially available polyolefins useful in making the foamed polyolefin include, for example, those from The Dow Chemical Company under the tradenames DOWLEX, ELITE, VERSIFY, and LDPE (high pressure polyethylenes).

Alternatively, other mechanisms for softening the polyolefin foam may be utilized, including for example the use of direct or indirect heat along the predetermined lines to form crease lines.

In yet another alternative, metal particles may be embedded in the foamed polyolefin film and the microwave energy applied along the predetermined lines to cause heating of the foamed polyolefin along the predetermined lines.

In a first embodiment the disclosure provides a flexible container comprising a multilayer structure which comprises a barrier layer; a sealing layer; and a foamed polyolefin disposed between the barrier and sealing layers; wherein the multilayer structure includes crease lines formed by localized thermal compaction of at least the foamed polyolefin layer.

The disclosure further provides a process for making a flexible container according to the disclosure comprises (a) selecting a multilayer structure having a barrier layer, a sealing layer and a foamed polyolefin layer disposed between the barrier and sealing layers; and (b) thermally creasing the film along predetermined lines to form crease lines in the multilayer structure.

The multilayer structure comprises a barrier layer, a sealing layer and a foamed polyolefin. The multilayer structure may further comprises one or more adhesives between the various layers, such as between a foam layer and a barrier layer or between the barrier layer and the outside layer. Such adhesives are well known in the art and include, for example, water-based or solvent-based adhesive systems, including cyanate, polyurethane and acrylic based systems.

Nonlimiting examples of suitable materials for the barrier layer include poly(ethylene terephthalate) (PET), polyamide, ethylene vinyl alcohol polymer (EVOH), polyvinylidene chloride (PVDC), propylene-based polymer (such as biaxially oriented polypropylene or OPP), metal foil (such as aluminum foil) and metallized polymer layers. Another example of a barrier layer includes a polymer layer onto which a metal foil layer has been adhered by use of an adhesive.

The sealing layer is any such layer within the skill in the art for instance as disclosed in such references as U.S. Pat. Nos. 6,117,465; 5,288,531; 5,360,648; 5,364,486; 5,508,051; 5,721,025; 4,521,437; 5,288,531; and 6,919,407 which are incorporated herein by reference to the fullest extent permitted by law. Nonlimiting examples of suitable materials for the sealant layer include ethylene or ethylene/propylene composed polymers having a melting point less than 130° C. All individual values and subranges from less than 130° C. For example the sealing layer polymer may have a melting point less than 130° C., or in the alternative, less than 125° C., or in the alternative, less than 124° C., or in the alternative, less than 123° C. In yet another embodiment, the melting point is equal to or greater than 92° C. For example, the melting point can be equal to or greater than 92° C., or in the alternative, equal to or greater than 93° C., or in the alternative, equal to or greater than 94° C., or in the alternative, equal to or greater than 95° C., or in the alternative, equal to or greater than 96° C., or in the alternative, equal to or greater than 97° C., or in the alternative, equal to or greater than 98° C. Polyolefin-based polymers useful in the sealant layer include those commercially available from The Dow Chemical Company under the names ELITE, VERSIFY, AFFINITY, INFUSE, SEALUTION, PRIMACOR and DOWLEX. Low density polyethylenes useful in the sealant layer include plastomers and copolymers of ethylene with butene, pentene, hexene, octene, propylene. vinyl acetate, methacrylic acid and ethyl acrylate.

### Specific Embodiments

In another embodiment, the present disclosure further provides the flexible container and method of making a flexible container according to any embodiment disclosed herein except that the foamed polyolefin is a closed cell foam.

In another embodiment, the present disclosure further provides the flexible container and method of making a flexible container according to any embodiment disclosed herein except that the foamed polyolefin, before compaction, has a thickness from 50 to 300 microns. All individual values and subranges from 50 to 300 microns are included and disclosed herein; for example, the thickness of the third layer can be from a lower limit of 50, 100, 150, 200, or 250 microns to an upper limit of 75, 125, 175, 225, 275 or 300 microns. For example, the third layer thickness can be from 50 to 300 microns, or in the alternative, from 50 to 150 microns, or in the alternative, from 150 to 300 microns, or in the alternative, from 225 to 275 microns.

In a specific embodiment, the foamed polyolefin is compacted from 5 to 50 volume percent following the thermal creasing. All individual values and subranges from 5 to 50 volume percent are included and disclosed herein; for example, the amount of compaction of the foamed polyolefin following the thermal creasing may range from a lower limit of 5, 15, 25, 35 or 45 volume percent to an upper limit of 10, 20, 30, 40 or 50 volume percent. For example, the amount of compaction of the foamed polyolefin may be from 5 to 50 volume percent, or in the alternative, from 5 to 25 volume percent, or in the alternative, from 25 to 50 volume percent, or in the alternative, from 20 to 35 volume percent.

In another embodiment, the present disclosure further provides the flexible container and method of making a flexible container according to any embodiment disclosed herein except that the barrier layer is a metal foil layer or metallized polymer layer.

In another embodiment, the present disclosure further provides the flexible container and method of making a flexible container according to any embodiment disclosed herein except that the barrier layer is from 3 to 30 microns. All individual values and subranges from 3 to 30 microns are included and disclosed herein; for example, the thickness of the barrier layer can be from a lower limit of 3, 5, 7, 12, 16, 20 24 or 28 microns to an upper limit of 6, 10, 14, 18, 22, 26 or 30 microns. For example, the thickness of the barrier layer can be from 3 to 30 microns, or in the alternative, from 12 to 22 microns, or in the alternative, from 12 to 15 microns.

In another embodiment, the present disclosure further provides the flexible container and method of making a flexible container according to any embodiment disclosed herein except that the barrier layer comprises aluminum foil. In a particular embodiment, the barrier layer comprises a metal foil having a thickness from 5 to 35 microns. All individual values and subranges from 5 to 35 microns are included and disclosed herein; for example, the thickness of the metal foil can range from a lower limit of 5, 15, 25 or 30 microns to an upper limit of 10, 20, 30 or 35 microns. For example, the metal foil layer can be from 5 to 35 microns, or in the alternative, from 5 to 20 microns, or in the alternative, from 15 to 35 microns, or in the alternative, from 5 to 10 microns, or in the alternative, from 6 to 9 microns.

In another embodiment, the present disclosure further provides the flexible container and method of making a flexible container according to any embodiment disclosed herein except that the barrier layer is a metallized polypropylene.

In another embodiment, the present disclosure further provides the flexible container and method of making a flexible container according to any embodiment disclosed herein except that the barrier layer comprises a polyamide.

In another embodiment, the present disclosure further provides the flexible container and method of making a flexible container according to any embodiment disclosed herein except that the barrier layer is laminated onto the remaining components of the multilayer structure.

In another embodiment, the present disclosure further provides the flexible container and method of making a flexible container according to any embodiment disclosed herein except that the sealing layer has a thickness from 10 to 40 microns. All individual values and subranges from 10 to 40 microns are included and disclosed herein; for example, the thickness of the sealing layer can be from a lower limit of 10, 15, 20, 25, 30 or 35 microns to an upper limit of 11, 16, 21, 26, 31, 36 or 40 microns. For example, the sealing layer thickness can be from 10 to 40 microns, or in the alternative, from 25 to 40 microns, or in the alternative, from 10 to 15 microns, or in the alternative, from 15 to 20 microns.

In another embodiment, the present disclosure further provides the flexible container which comprises a multilayer structure as described herein except that the multilayer structure does not include a sealing layer.

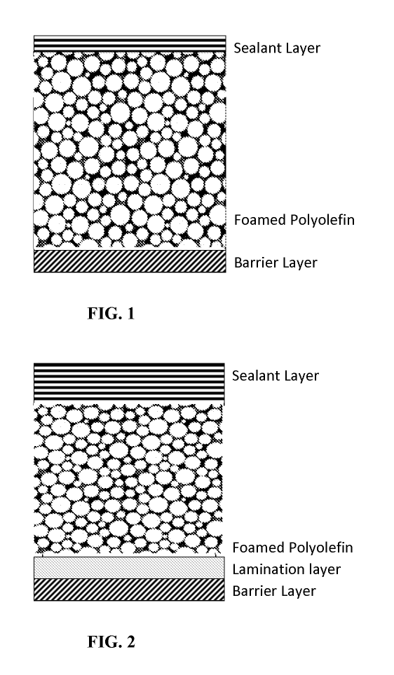

FIG. 1 illustrates a first multilayer structure which may be used in the disclosed flexible container. The multilayer structure of FIG. 1 may be made by thermal lamination. As can be seen in FIG. 1, the multilayer structure includes a sealant layer, a barrier layer and a foamed polyolefin between the sealant and barrier layers.

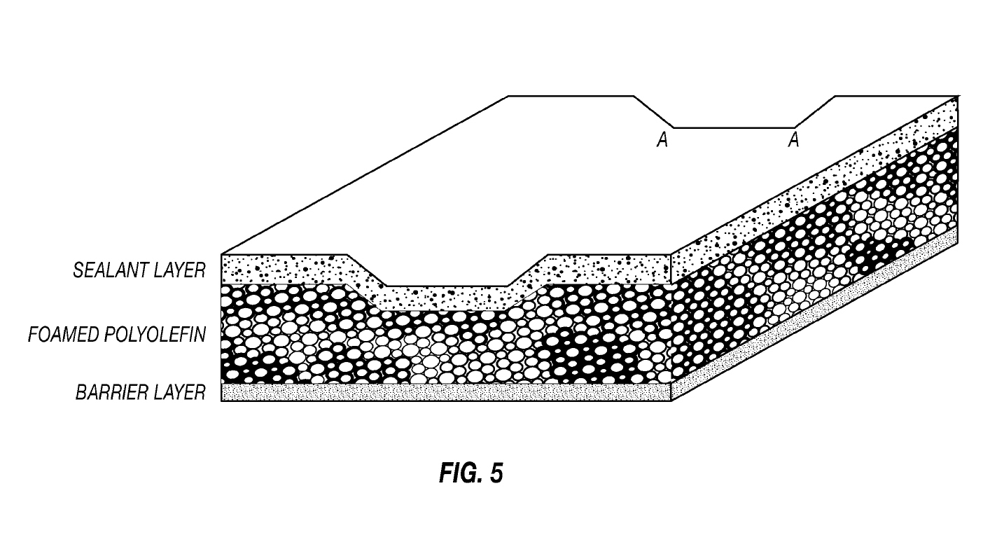

FIG. 5 illustrates the structure of FIG. 1 having thermal crease therein. In a particular embodiment, the bottom of the crease has a width (shown as line A-A) less than or equal to 8 mm. All individual values and subranges less than or equal to 8 mm are included and disclosed herein. The bottom of the crease width may be from an upper limit of 8 mm, or in the alternative, from 7 mm, or in the alternative from 6 mm, or in the alternative from 5 mm. In a particular embodiment, the bottom crease width is from a lower limit of 1 mm. All individual values and subranges are included and disclosed herein. For example the bottom width of the crease may range from 1 to 8 mm, or in the alternative, from 1 to 5 mm, or in the alternative, from 2 to 7 mm.

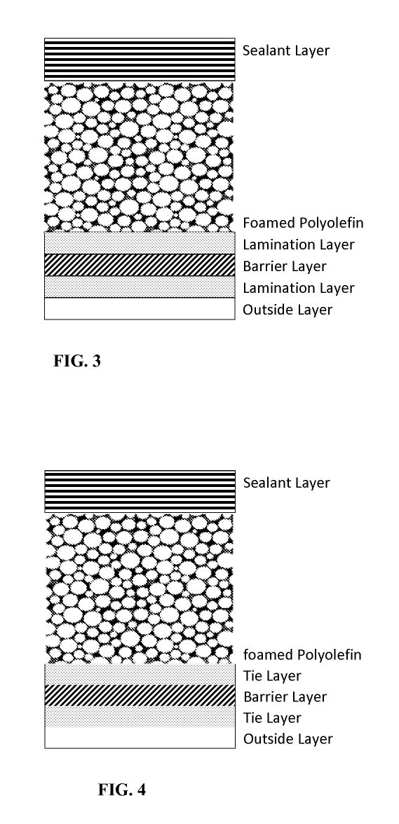

FIGS. 2-3 illustrate second and third embodiments, respectively, of a multilayer structure useful in the disclosed flexible container. FIGS. 2-3 illustrate multilayer structures which may be prepared by adhesive or extrusion lamination. Referring to FIG. 2, the multilayer structure includes a first lamination layer between the foamed polyolefin and the barrier layer. Suitable materials for use in the first lamination layer include polyethylene, LDPE, functionalized polyolefins, ethylene/acrylic acid copolymers, ethylene/methacrylic acid copolymers, EVA (ethylene vinyl acetate copolymers), EBA (ethylene butyl acrylate copolymers), and any combination thereof. The first lamination layer may have a thickness from 5 to 50 microns.

Referring to FIG. 3, the multilayer structure may alternatively include an outer layer and a second lamination layer between the outer layer and the barrier layer. The thickness of the second lamination layer has the same range as discussed for the first lamination layer, i.e., from 5 to 50 microns. All individual values and subranges from 5 to 50 microns are included and disclosed herein; for example, the first and second lamination layers thickness can be from a lower limit of 5, 15, 35, or 45 microns to an upper limit of 10, 20, 30, 40 or 50 microns. The first and second (when present) lamination layers may have the same or different thicknesses. Suitable materials for use in the second lamination layer include polyethylene, LDPE, functionalized polyolefins, ethylene/acrylic acid copolymers, ethylene/methacrylic acid copolymers, EVA (ethylene vinyl acetate copolymers), EBA (ethylene butyl acrylate copolymers), and any combination thereof. The first and second (when present) lamination layers may comprise the same or different polymeric components.

FIG. 4 illustrates a fourth embodiment of a multilayer structure useful in the disclosed flexible container. The multilayer structure of FIG. 4 may be made by coextrusion processes, provided the barrier layer is a polymeric layer (without metallization). Referring to FIG. 4, the multilayer structure includes a sealant layer, a barrier layer and a foamed polyolefin between the sealant and barrier layers, an outer layer, a first tie layer between the foamed polyolefin and the barrier layer, and a second tie layer between the outer layer and the barrier layer. Suitable materials for use in the first and second tie layers include polyethylene, LDPE, functionalized polyolefins, ethylene/acrylic acid copolymers, ethylene/methacrylic acid copolymers, EVA (ethylene vinyl acetate copolymers), EBA (ethylene butyl acrylate copolymers), and any combination thereof. The first and second tie layers may have a thickness from 1 to 15 microns.

In another embodiment, the present disclosure further provides the flexible container and method of making a flexible container according to any embodiment disclosed herein except that the container is a monolithic container when at least one-half filled with a liquid or a solid.

In another embodiment, the present disclosure further provides the flexible container and method of making a flexible container according to any embodiment disclosed herein except that the container is capable of being aseptically prepared and filled.

In another embodiment, the present disclosure further provides the flexible container and method of making a flexible container according to any embodiment disclosed herein except that an internal volume of the container is less than or equal to 500 milliliters (mls). All individual values and subranges from less than or equal to 500 mls are included and disclosed herein. For example, the internal volume of the container may be less than or equal to 500 mls, or in the alternative, less than or equal to 350 mls, or in the alternative, less than or equal to 250 mls.

In another embodiment, the present disclosure further provides the method of making a flexible container according to any embodiment disclosed herein except that the method further comprises (c) folding the film along the crease lines to form a bottom portion of a container. In yet another embodiment, the method may further comprise (d) filling the container with contents in a vertical form fill seal process in specification; and (e) sealing a top portion of the container to form a closed container.

In another embodiment, the present disclosure further provides the method of making a flexible container according to any embodiment disclosed herein except that the thermal creasing comprises application of ultrasonic waves along the predetermined lines.

In another embodiment, the present disclosure further provides the method of making a flexible container according to any embodiment disclosed herein except that the thermal creasing comprises application of a heated bar along the predetermined lines.

In another embodiment, the present disclosure further provides the method of making a flexible container according to any embodiment disclosed herein except that the sealing a top portion of the container and/or sealing the bottom portion of the container may be accomplished by any method as used in forming such containers. Such sealing methods include, for example, ultrasonic sealing, heat sealing, and induction sealing. Known form-fill-sealing techniques, such as that described in Packaging Machinery Operation, Chapter 8: Form-Fill-Sealing, by C. Glenn Davis (Packaging Machinery Manufacturers Institute, 2000 K Street, N.W., Washington, D.C. 20006); The Wiley Encyclopedia of Packaging Technology, Marilyn Bakker, Editor-in-chief, pp. 364-369 (John Wiley & Sons); U.S. Pat. No. 5,288,531 (Falla et al.), U.S. Pat. No. 5,721,025 (Falla et al.), U.S. Pat. No. 5,360,648 (Falla et al.) and U.S. Pat. No. 6,117,465 (Falla et al.); other manufacturing techniques, such as that discussed in Plastic Coated Substrates, Technology and Packaging Applications (Technomic Publishing Co., Inc. (1992)), by Kenton R. Osborn and Wilmer A Jenkens, pp. 39-105 may be used. All of these patents and references are incorporated herein by reference. Other manufacturing techniques are disclosed in U.S. Pat. No. 6,723,398 (Chum et al.), incorporated herein by reference.

In another embodiment, the present disclosure further provides the method of making a flexible container according to any embodiment disclosed herein except that the thermal creasing comprises subjecting the multilayer structure to ultrasonic waves. Any ultrasonic frequency may be used. In a particular embodiment, the ultrasonic frequency is 20 kHz. In another embodiment, the ultrasonic frequency is 35 kHz.

Creasing:

In a particular embodiment, the creasing step is performed with specialized equipment such as equipment available from companies such as SCHOBER Technologies GmbH, D-71735 Eberdingen (Germany). There are three possible machine set-ups: either a creasing module could be inserted as a last station of the assembling and printing equipment or it can be inserted as a station into the packaging filling equipment, before the longitudinal seal is being formed or thirdly the creasing equipment stays off-line as self-standing auxiliary module. If the equipment is built as module and inserted into the process of making the packaging structure it has to be positioned after having at minimum a guiding mark on the laminate for proper positioning. The guiding mark is typically called a printing mark and applied on a film component by a printing technology before, while making the laminate or as a surface printed mark on a final laminate. In one embodiment, the creasing module might be inserted as the first operation in the packaging forming and filling equipment.

Package Forming:

The forming of a packaging may be accomplished, in some embodiments, as is known vertical form fill and sealing (so called VFFS) lines. Exemplary VFFS lines are manufactured for flexible pouches by BOSCH GmbH (Waiblingen—Germany), ROVEMA (Fernwald—Germany), OYSTAR Holding GmbH (Stutensee-Germany), and SHIKOKU KAKOKI Co. Ltd. (Japan).

These commonly used equipment are fed from a rolled-up laminate. The creased laminate will form into a vertical tube around a hollow product profile of different shape (round, square, elliptic, hexagonal, octagonal) along the crease lines. The laminate is vertically welded along its length and forms a tube in the shape given by the inner hollow profile and the crease lines. After the vertical tube is formed, the product will be filled through the inner and hollow profile. At this end of the process the equipment applies a pair of horizontally positioned welding jaws to form transverse seals. The upper jaws close the bottom of the next coming pouch, whereas the lower pair of jaws locks the filled volume in the lower containment. Depending on the welding technology chosen, this operation might be performed through the filled product and the sealing operation will dispose the filled product from the interlayers by mechanical force. Depending on the material selection the thermoplastic may seal through the contamination when supported by enough pressure during the operation. A knife positioned between the lower and upper pair of transversal jaws may cut the pouches from each other and allow for forming and fixing a bottom of a packaging. While the vertical lines will be formed by passing over the inner and hollow profile, the bottom will need to be folded along additional crease lines and by guiding the two edges and force them either as bottom triangles or side flaps and fix them by means of lowest elastic recovery laminates or specifically mounted fixing devises (such as hot melt applicators or hot air welding spots). The crease lines assist in suppressing the elastic recovery and further in defining the folding line in this operation.

The present invention may be embodied in other forms without departing from the spirit and the essential attributes thereof, and, accordingly, reference should be made to the appended claims, rather than to the foregoing specification, as indicating the scope of the invention.

1. A flexible container comprising:
a multilayer structure which comprises
a barrier layer, wherein the barrier layer is a metal foil layer or metallized polymer layer;
a sealing layer;
a foamed polyolefin layer between the barrier and sealing layers, wherein the foamed polyolefin is a closed cell foam;
wherein the container includes crease lines formed by localized thermal compaction of the foamed polyolefin.

2. The flexible container according to claim 1, wherein the container is a monolithic container when at least one-half filled with a liquid or solid.

3. The flexible container according to claim 1, wherein the container is capable of being aseptically prepared and filled.

4. The flexible container according to claim 1, wherein an internal volume of the container is less than or equal to 500 mls.

5. The flexible container according to claim 1, wherein the barrier layer comprises aluminum foil.

6. The flexible container according to claim 1, wherein the barrier layer is a metallized polypropylene.

7. The flexible container according to claim 5, wherein the aluminum foil is between 5 and 35 microns in thickness.

8. The flexible container according to claim 1, wherein the barrier layer comprises polyamide, ethylene vinyl alcohol polymer, polyvinylidene chloride, or any combination thereof.

9. The flexible container according to claim 1, further comprising a first lamination layer between the foamed polyolefin and the barrier layer.

10. The flexible container according to claim 9, further comprising an outside layer and a second lamination layer between the outside layer and the barrier layer.

11. The flexible container according to claim 1, further comprising a first tie layer between the foamed polyolefin and the barrier layer.

12. The flexible container according to claim 11, further comprising an outside layer and a second tie layer between the barrier layer and the outside layer.

13. A process of preparing a flexible container comprising the steps of
(a) selecting a multilayer structure having a barrier layer, wherein the barrier layer is a metal foil layer or metallized polymer layer, a sealing layer and a foamed polyolefin layer disposed between the barrier and sealing layers, wherein the foamed polyolefin is a closed cell foam; and
(b) thermally creasing the film along predetermined lines to form crease lines in at least the foamed polyolefin layer.

14. The process according to claim 13, further comprising;
(c) folding the film along the crease lines to form a bottom portion of a container.

15. The process according to claim 14, further comprising:
(d) filling the container with contents in a vertical form fill seal process in specification; and
(e) sealing a top portion of the container to form a closed container.

16. The process according to claim 13, wherein the thermal creasing comprises application of ultrasonic waves along the predetermined lines.

17. The process according to claim 13, wherein the thermal creasing comprises application of a heated bar along the predetermined lines.
